(19) United States
(12) Patent Application Publication
(10) Pub. No.: US 2005/0268437 A1
(43) Pub. Date: Dec. 8, 2005

(54) Hose clamp and process of clamping hoses

(76) Inventor: William Steadman, Port Saint Lucie, FL (US)

Correspondence Address: WATTS, HOFFMANN CO., L.P.A., Ste. 1750, 1100 Superior Ave., Cleveland, OH, 44114, US

(21) Appl. No.: 10/863,675

(22) Filed: Jun. 8, 2004

(51) Int. Cl. F16L 33/08

(52) U.S. Cl. 24/274 R

(57) ABSTRACT

A hose clamp is disclosed which includes an elongate metal band having a set of longitudinally and uniformly spaced clamping projections. A housing element is secured to the band to delineate a housing space. A clamp tightening element is rotatably mounted in the space. The clamping element includes perimetrical threads formed therein for engagement with selected ones of the projections. The elements include coacting surfaces for locating the clamp element in a tightening position relative to the band and allowing band tightening rotation of the clamp element as the thread engages at least a certain one of the projections to tighten the clamp about a clamped object.

This invention relates to hose clamps and more particularly to a hose clamp that is simple and quickly installed and to a method of clamp installation and removal.

### BACKGROUND

There are many applications where flexible hoses are connected to the ends of metal tubes. Connection of radiator hoses to vehicle radiators is but one example. When such connections are made it is necessary to clamp hose ends against metal tubes to which the hoses are connected in fluid tight relationship. A wide variety of clamp types and sizes are provided in the market place.

While a wide variety is provided, there is a need for clamps which will readily fit a range of sizes greatly reduce the size of inventories. There is also a need for clamps which can be positioned around hoses after the hoses have been telescoped onto tubes to which they are being connected. Further there is a need for clamps which can be quickly tightened about hoses of a range of sizes. One proposal for such a clamp is described and claimed in my copending application Ser. No. 10/488,647 filed Mar. 4, 2004 under the title Securing Arrangement.

### SUMMARY OF THE DISCLOSURE

An elongated flexible, preferably metal, band is provided that extends from a free end to a remote housing end. A housing element is secured to the band near the housing end such that the housing element and the band together define a housing. A tightener is positioned within the housing. The tightener has a perimeter tooth formation for clamp tightening coaction with projections formed in the band.

The tightener has a frustum formed at one end for thrust absorbing coaction with a housing internal, frusto-conical surface when the tightener is in a band tightening position. Tightening tool coacting surfaces are provided near the end of the tightener remote from the frustum. The tightener is moveable from its tightening position to a band feed position spaced from the band for facile and rapid insertion and removal of the band to and from the housing.

### BRIEF DESCRIPTION OF THE DRAWINGS

FIG. 1 is a perspective view of a clamp tightening section of the clamp;

FIG. 2 is an enlarged view of a clamp tightening section of the band showing the housing in section with the tightener in solid lines in its band feed position and the band tightening position in phantom;

FIG. 2A is a fragmentary enlarged view of a tightener tooth:

FIG. 2B is a view corresponding to FIG. 2 but showing the tightener in its tightening position in solid lines;

FIG. 3 is an end view of the clamp as seen from the plane indicated by the line 3-3 of FIG. 1; and,

FIG. 4 is and exploded view showing the elements of the improved clamp.

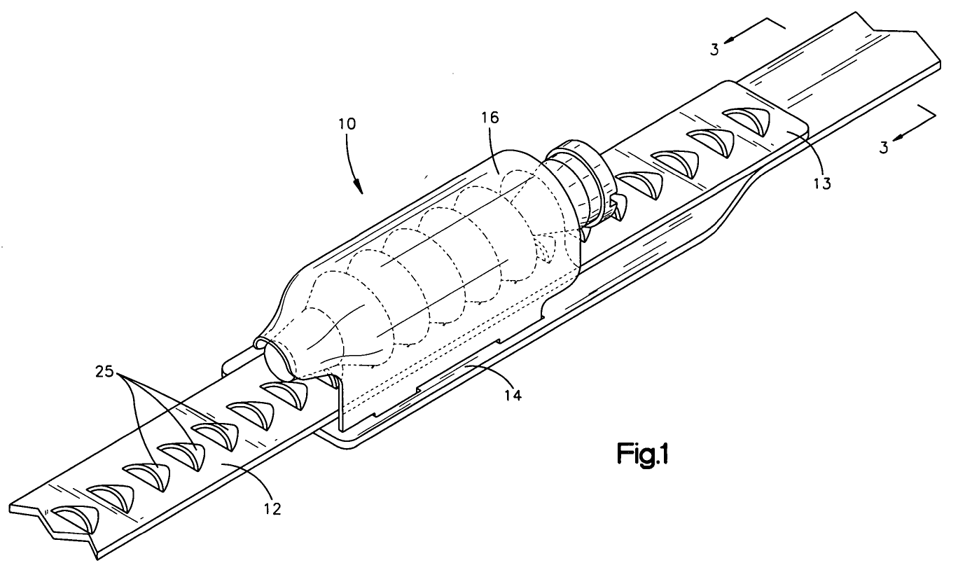

### DETAILED DESCRIPTION OF THE PREFERRED EMBODIMENT

Referring now to the drawings, a novel and improved clamp of the present application is shown generally at 10. The clamp includes an elongated, flexible, metal band 12 extending from a free-end 13 to a housing end or portion 14.

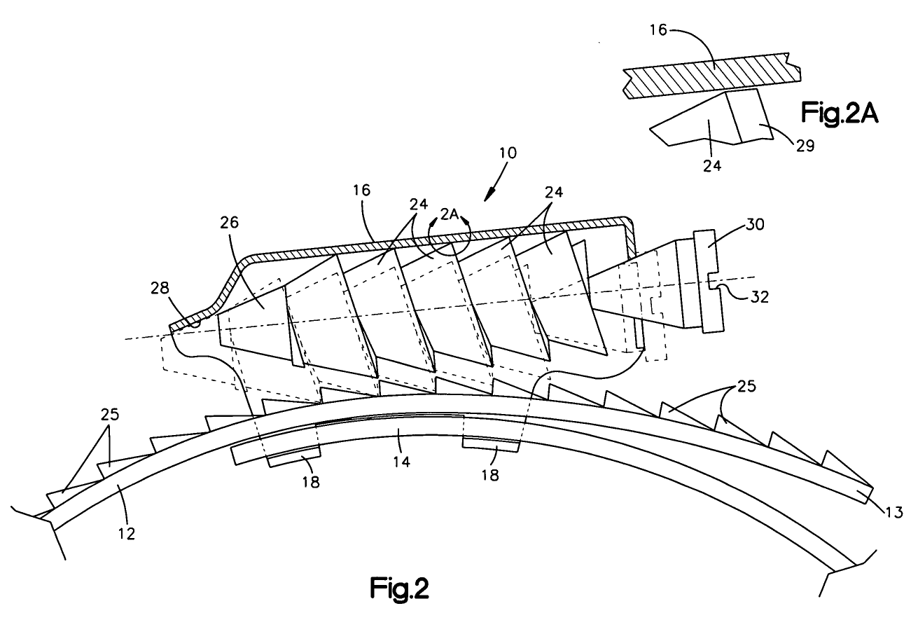

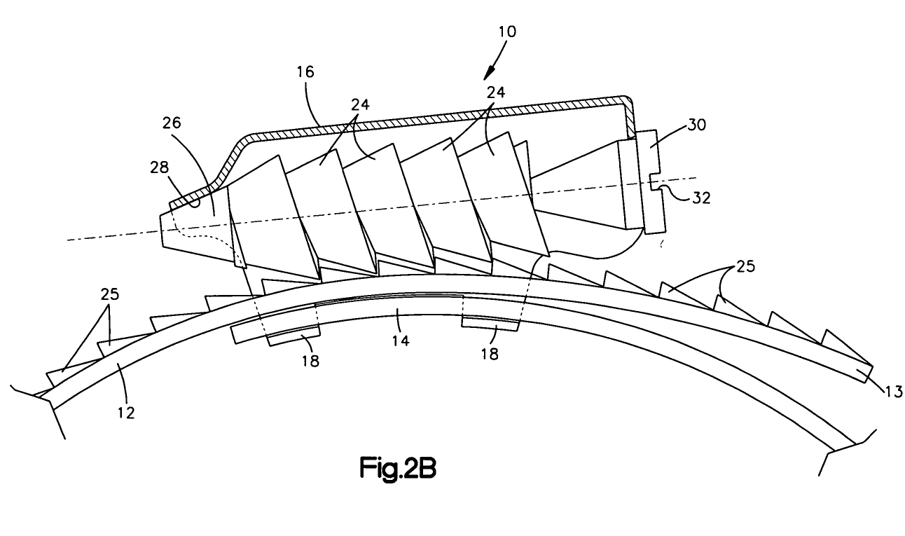

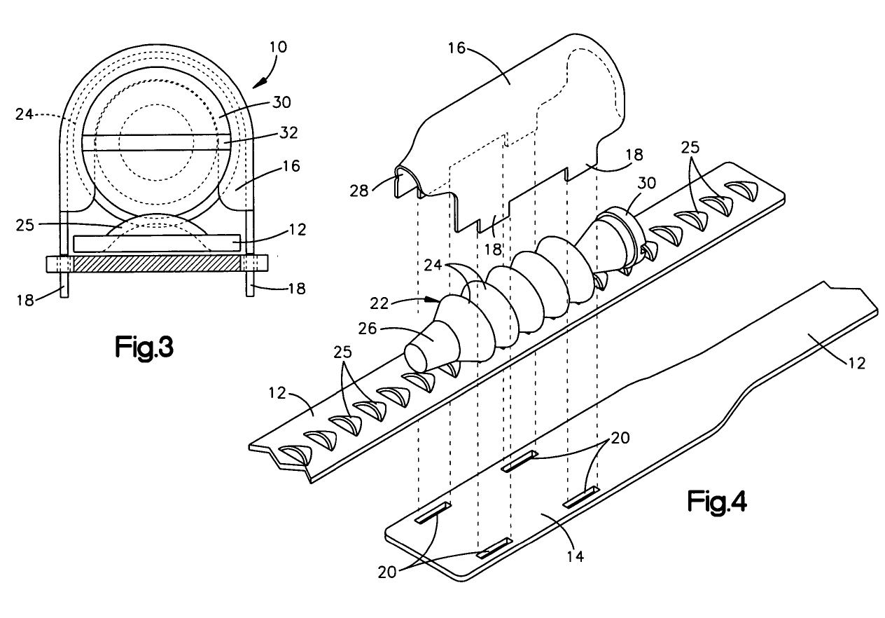

A housing body 16 is provided. The housing body 16 includes lugs 18, which project through apertures 20 in the housing portion 14 of the band. As is best seen in FIG. 2, the lugs 18 are bent over to secure the housing portion 14 and the housing body 16 together to form a completed open-ended, housing.

A clamp element 22 is disposed within the housing. The clamp element 22 includes spirally formed perimiteral thread with functions as teeth 24. The teeth 24 selectively engage a plurality of band projections 25. The projections are uniformly spaced and preferably formed by stamping. The threads and projections are in position for coacting and tightening of the clamp when the clamp element 22 is in the phantom line position of FIG. 2. In that position, a forward frusto-conical shaped surface 26 of the clamp element 22 engages an internal frusto-conical shaped segment 28 of the housing 16. Coaction of the frusto-conical shaped surfaces 26, 28 as the clamp is being tightened provides thrust-bearing action.

While not shown if FIGS. 2 and 2B, each tooth 24 includes a rearward and outward thrust bearing flat as shown in FIG. 2 A. The flats 29 coact with an inner surface of the housing body 16 as the clamp is tightened to absorb thrust of the clamp element 22 in an upward direction as viewed in FIGS. 2 and 2B.

The clamp element 22 has a disengaged position as shown in solid lines in FIG. 2. The disengaged position provides facile insertion and removal of the free end 13 of the band 12 into and from the housing.

The clamp element 22 includes a tool formation end 30 remote from the frustum 26. As is best seen by an examination of FIG. 2, the formation end 30 includes tool engagement surfaces in the form of a slot 32. In the embodiment shown in the drawings, the slot is formed to receive a standard, straight, screwdriver for band tightening rotation. Obviously, the formation end 30 can be shaped to receive other tools such as having wrench receiving external flats or an x-type screwdriver slot for a Phillips head type screwdriver.

One of the outstanding advantages of the present invention is that one clamp can fit a wide range of hose sizes. If a hose being clamped is relatively small in the range of sizes a given clamp can be used on a portion of the band adjacent the free end, may be cut off either before or after the free end is fed into the clamp housing.

Operation

When a hose is to be clamped with a clamp of the present disclosure, the band 12 is wrapped around the hose to be clamped. The clamp element 22 is moved to its disengaged position and the free end 13 of the band is inserted into the housing in a space between the clamp element and the housing portion 14 of the band 12. The free end is fed further until the band 12 is relatively closely surrounding the hose to be clamped.

The clamp element is then shifted to the tightening position shown in phantom in FIG. 2. A tool is then used to rotate the clamp element to tighten the clamp band about the hose. In the disclosed embodiment, the threads 24 on the clamp element are right-hand threads so tightening is achieved by inserting a screwdriver into the slot 32 and rotating clockwise until the desired clamping pressure is achieved.

For clamp removal one simply counter-rotates the clamp element 22 until there is sufficient looseness to allow movement of the clamp element to its disengaged position. Once the clamp element is in the disengaged position, the band may be fed in through the housing in a loosening direction until the free-end 13 is fed to and through the housing.

1. A hose clamp comprising;
a) an elongate metal band having a set of longitudinally and uniformly spaced ratchet projections formed therein;
b) a housing element secured to the band to delineate a housing space;
c) a clamp tightening element rotatably mounted in the space and including perimetrical threads formed therein for engagement with selected ones of the projections; and,
d) the elements including coacting surfaces for locating the clamp element in a tightening position relative to the band and allowing band tightening rotation of the clamp element as the thread engages at least a certain one of the projections whereby to tighten the clamp about a clamped object.

2. The clamp of claim 1 wherein the elements also have a disengaged position wherein the band and the housing may be relatively moved longitudinally of the band without engagement of the threads with the teeth thereby enabling quick relative positioning the clamp and an item to be clamped.

3. The clamp of claim 1 wherein the housing includes walls defining a conical recess to provide one of the coacting surfaces and the clamp element includes a conical surface which is the other coacting surface and is complemental with the recess to function as a load absorbing bearing when the clamp is being tightened.

4. The clamp of claim 3 wherein the clamp element has an end formation adapted to receive a tool for rotating the clamp element and thereby tighten the clamp about an object being clamped.

5. The clamp of claim 4 wherein the end formation is a screwdriver receiving slot.

6. The clamp of claim 1 wherein the clamp element has an end formation adapted to receive a tool for rotating the tightening element and thereby tighten the clamp about an object being clamped.

7. The clamp of claim 6 wherein the end formation is a screwdriver receiving slot.

8. The clamp of claim 1 wherein the elements have a band feed position wherein the band may be fed through the housing in a preliminary tightening of the clamp about an object to be clamped without band tightening engagement of the thread and the projections.

9. The clamp of claim 1 wherein the housing element includes lugs projecting through an associated aperture in the band for connection of the housing element and the band together to form the housing.

10. A hose clamp comprising,
a) an elongate flexible band including a transversely enlarged end housing portion having lug receiving slots therein;
b) a housing body including lugs each projecting through an associated one of the slots and being bent over to secure the body to the portion and form a body;
c) the band including a plurality of spaced ratchet elements each formed by displacing band metal from a body of the band;
d) a tightener including a perimetrical screw surface and a lead end thrust portion in the form of a conical frustum, the frustum being adapted for thrust absorbing engagement with a complemental interior surface of the body;
e) the screw surface being progressively engageable with the ratchet elements upon rotation of the tightener relative to the housing and the band; and'
f) the tightener including tool engagement surfaces for rotation producing engagement with a tool.

11. The clamp of claim 10 wherein the engagement surfaces are for engagement with a screwdriver.

12. The clamp of claim 10 wherein the tightener is axially moveable in the housing between a manual advance position wherein the tightener is spaced from the band to allow facile advance of the band relative to the housing and a band tightening position wherein the screw surface is in driving engagement with at least one of the ratchet elements for tightening the band upon rotation of the tightener and thereby to apply clamping force to and item being clamped.

13. A process of clamping a hose comprising,
a) wrapping a clamp band around a hose to be clamped;
b) after the band has been wrapped about the hose whereby to form a clamp loop, inserting a free end of the band into a band housing formed on the band at a location spaced from the free end;
c) prior to the insertion of the free end into the housing positioning a band tightener disposed within the housing in a band feed position such that the tightener and the housing delineate an unobstructed band passageway through the housing for rapid passage of the free end both into and from the passageway;
d) shifting the tightener to a clamping position wherein threads on the perimeter of the tightener engage ratchet projections formed in the band; and,
e) rotating the tightener to cause the teeth to co act with the projections and thereby compress and clamp the hose.

14. A process of removing a clamp installed by the process of claim 13 from a hose comprising;
a) counter rotating the tightener to loosen be band,
b) shifting the tightener to its band feed position; and,
c) removing the free end of the band from the housing.
